(19) United States
(12) Patent Application Publication
(10) Pub. No.: US 2025/0192387 A1
(43) Pub. Date: Jun. 12, 2025

(54) LEAD WITH ELECTRICALLY INSULATING RESIN FILM

(71) Applicant: SUMITOMO ELECTRIC INDUSTRIES, LTD., Osaka (JP)

(72) Inventors: Masakazu IKAI, Tochigi (JP); Kengo GOTO, Tochigi (JP)

(21) Appl. No.: 18/932,940

(22) Filed: Oct. 31, 2024

(30) Foreign Application Priority Data
Dec. 12, 2023 (JP) 2023-209224

(51) Int. Cl. H01M 50/534; H01B 7/02; H01M 50/533

(52) U.S. Cl. CPC H01M 50/534; H01B 7/02; H01M 50/533

(57) ABSTRACT

A lead includes a conductor and an electrically insulating resin film. The conductor includes tapered conductor portions, each having a thickness decreasing with increasing distance from a first center that is a center of the conductor. The electrically insulating resin film has tapered resin portions each having a thickness decreasing with increasing distance from the first center. The tapered conductor portions have first conductor ends close to the first center. The tapered resin portions have first resin ends closer to the first center and second resin ends farther from the first center. Each of the first resin ends is at the same position of a corresponding one of the first conductor ends or is closer to the first center than the corresponding one is. Each of the second resin ends is farther from the first center than a corresponding end of the conductor is.

### CROSS REFERENCE TO RELATED APPLICATIONS

This application claims priority based on Japanese Patent Application No. 2023-209224 filed on Dec. 12, 2023, and the entire contents of the Japanese patent application are incorporated herein by reference.

### TECHNICAL FIELD

The present disclosure relates to a lead with an electrically insulating resin film.

### BACKGROUND

Patent literature (Japanese Unexamined Patent Application Publication No. 2017-117705) discloses a lead member in which a pair of electrically insulating resin films are bonded to both surfaces of a conductor made of a metal foil at positions other than two ends in the length direction of the conductor.

### SUMMARY

A lead with an electrically insulating resin film of the present disclosure includes a plate-shaped conductor with a top surface and a bottom surface each having a rectangular shape, and an electrically insulating resin film including a first electrically insulating resin film disposed on the top surface of the conductor and a second electrically insulating resin film disposed on the bottom surface of the conductor. When the conductor is viewed from above along a vertical direction of the top surface, an axis along selected two sides facing each other is an X-axis, and an axis orthogonal to the X-axis is a Y-axis, the conductor includes tapered conductor portions provided one each at two ends of the conductor along the X-axis, the tapered conductor portions each having a thickness that decreases with increasing distance from a first center that is a center of the conductor along the X-axis. The first electrically insulating resin film and the second electrically insulating resin film are arranged so as to cover the conductor by extending across the conductor along the X-axis such that the first and second electrically insulating resin films each have margin portions projecting from the two ends of the conductor and so as not to cover two ends of the conductor along the Y-axis, the margin portions of the first electrically insulating resin film overlapping the margin portions of the second electrically insulating resin film. In a cross-section of a multilayer body along the X-axis, the multilayer body including the electrically insulating resin film and the conductor laminated together, the multilayer body includes tapered resin portions each having a thickness that decreases with increasing distance from the first center. Each of the tapered conductor portions has a first conductor end close to the first center. Each of the tapered resin portions has a first resin end closer to the first center and a second resin end farther than the first resin end from the first center. Along the X-axis, a position of each of the first resin ends is the same as a position of a corresponding one of the first conductor ends or is closer than the position of the corresponding first conductor end to the first center. A position of each of the second resin ends along the X-axis is farther than a corresponding one of the two ends of the conductor along the X-axis from the first center.

### BRIEF DESCRIPTION OF THE DRAWINGS

FIG. 1 is an explanatory view of a battery employing a lead with an electrically insulating resin film according to an embodiment of the present disclosure.

FIG. 2 is a top view of the lead with the electrically insulating resin film according to the embodiment of the present disclosure.

FIG. 3A is a cross-sectional view taken along line A-A′ of FIG. 1.

FIG. 3B is another configuration example of a cross-sectional view taken along line A-A′ of FIG. 1.

FIG. 4 is a cross-sectional view taken along line B-B′ of FIG. 2.

FIG. 5 is a cross-sectional view taken along a plane that passes through a multilayer body in the case where an exterior body is thermally welded to the lead with the electrically insulating resin film prepared in Example 2.

### DETAILED DESCRIPTION

There have been cases where a void is formed between an exterior body and an electrically insulating resin film of a lead with the electrically insulating resin film when the lead with the electrically insulating resin film in which the electrically insulating resin films are arranged on the top and bottom surfaces of a conductor is thermally welded to the exterior body.

The void is a factor of weakening the adhesion between the exterior body and the insulating resin film.

A lead with an electrically insulating resin film having excellent adhesion to an exterior body can be provided.

Embodiments will be described below.

### DESCRIPTION OF EMBODIMENTS OF PRESENT DISCLOSURE

First, embodiments of the present disclosure will be listed and described. In the following description, the same or corresponding elements are denoted by the same reference numerals, and the same description thereof will not be repeated.
(1) A lead with an electrically insulating resin film according to an aspect of the present disclosure includes a plate-shaped conductor with a top surface and a bottom surface each having a rectangular shape, and an electrically insulating resin film including a first electrically insulating resin film disposed on the top surface of the conductor and a second electrically insulating resin film disposed on the bottom surface of the conductor. When the conductor is viewed from above along a vertical direction of the top surface, an axis along selected two sides facing each other is an X-axis, and an axis orthogonal to the X-axis is a Y-axis, the conductor includes tapered conductor portions provided one each at two ends of the conductor along the X-axis, the tapered conductor portions each having a thickness that decreases with increasing distance from a first center that is a center of the conductor along the X-axis. The first electrically insulating resin film and the second electrically insulating resin film are arranged so as to cover the conductor by extending across the conductor along the X-axis such that the first and second electrically insulating resin films each have margin portions projecting from the two ends of the conductor and so as not to cover two ends of the conductor along the Y-axis, the margin portions of the first electrically insulating resin film overlapping the margin portions of the second electrically insulating resin film. In a cross-section of a multilayer body along the X-axis, the multilayer body including the electrically insulating resin film and the conductor laminated together, the multilayer body includes tapered resin portions each having a thickness that decreases with increasing distance from the first center. Each of the tapered conductor portions has a first conductor end close to the first center. Each of the tapered resin portions has a first resin end closer to the first center and a second resin end farther than the first resin end from the first center. Along the X-axis, a position of each of the first resin ends is the same as a position of a corresponding one of the first conductor ends or is closer than the position of the corresponding first conductor end to the first center. A position of each of the second resin ends along the X-axis is farther than a corresponding one of the two ends of the conductor along the X-axis from the first center.

Since the conductor has the tapered conductor portions at the two ends, it is possible to prevent a gap from forming between the exterior body of the battery and the electrically insulating resin film near the margin portion. The effect of preventing the gap is particularly significant when the conductor is made thicker.

By arranging the positions of the first resin ends and the second resin ends of the tapered resin portions as described above, the length of each of the tapered resin portions along the X-axis can be increased, and the inclination of the outer surface of each of the tapered resin portions can be made gradual. Thus, when the lead with the electrically insulating resin film according to the aspect of the present disclosure is thermally welded to an exterior body, the resin of the exterior body easily fills the tapered resin portions, and the adhesion to the exterior body is enhanced, and the formation of the void can be prevented.
(2) In the above (1), the position of each of the second resin ends along the X-axis may be farther from the first center than is a second center that is a center of a corresponding one of the margin portions along the X-axis.

By setting the position of the second resin end along the X-axis to a position farther from the first center of the conductor than the second center of the margin portion is, the length of each of the tapered resin portions along the X-axis in particular can be increased, and the inclination of each of the tapered resin portions in particular can be made gradual. Thus, when the lead with the electrically insulating resin film according to the aspect of the present disclosure is thermally welded to the exterior body, the resin of the exterior body easily fills the tapered resin portions, and the adhesion to the exterior body is particularly enhanced, and the formation of the void can be prevented.
(3) In the above (1) or (2), the electrically insulating resin film may have two or more layers.

Since the electrically insulating resin film has two or more layers, the strength of the electrically insulating resin film, the adhesion between the electrically insulating resin film and the exterior body, and the adhesion between the electrically insulating resin film and the conductor after the exterior body is thermally welded to the electrically insulating resin film can be easily adjusted.
(4) In any one of the above (1) to (3), a thickness of the electrically insulating resin film may be 100 μm or greater.

By setting the thickness of the electrically insulating resin film to 100 μm or greater, it is possible to prevent a gap from forming between the electrically insulating resin film and the conductor.
(5) In any one of (1) to (4), a length of each of the margin portions along the X-axis may be 5 mm or less.

By reducing the length of the margin portion to 5 mm or less, the width of the seal portion sandwiching the lead with the electrically insulating resin film according to the aspect of the present disclosure, which is a foreign substance, can be shortened, thereby enhancing the sealing property.

### DETAILS OF EMBODIMENTS OF PRESENT DISCLOSURE

A specific example of a lead with an electrically insulating resin film according to one embodiment of the present disclosure (hereinafter, referred to as “the embodiment”) will be described below with reference to the drawings. It is noted that, the present invention is not limited to these examples, but is defined by the scope of the claims, and is intended to include all modifications within the meaning and scope equivalent to the scope of the claims.

In this specification, there may be cases that describes the names of the components are described by adding “first”, “second”, and the like, such as the first electrically insulating resin film and the second electrically insulating resin film. The terms “first”, “second”, and the like are used only to distinguish the respective members and to prevent confusion in the description, and do not represent arrangement, priority, and the like. Thus, when there is no particular possibility of confusion or when the electrically insulating resin film is collectively indicated, the electrically insulating resin film can be simply referred to as an electrically insulating resin film.

[Lead with Electrically Insulating Resin Film]

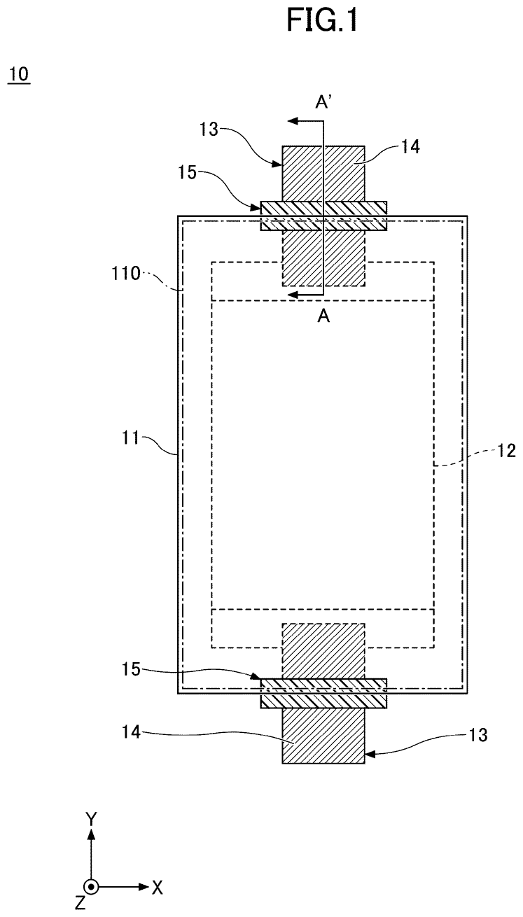

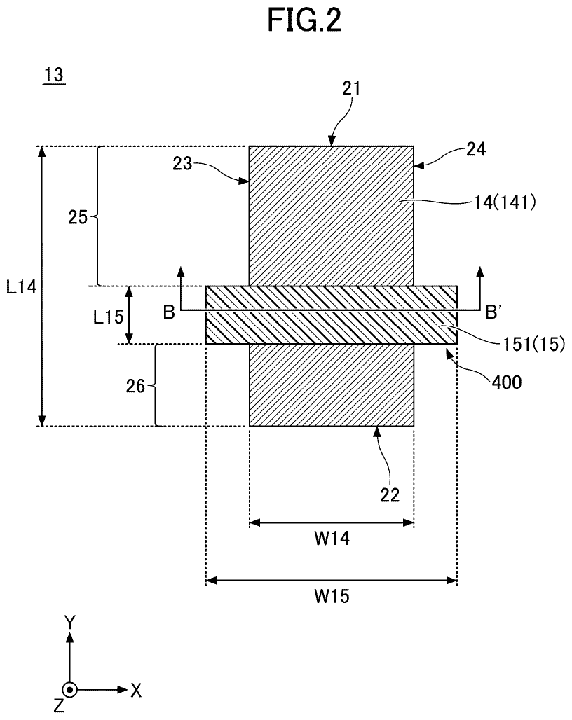

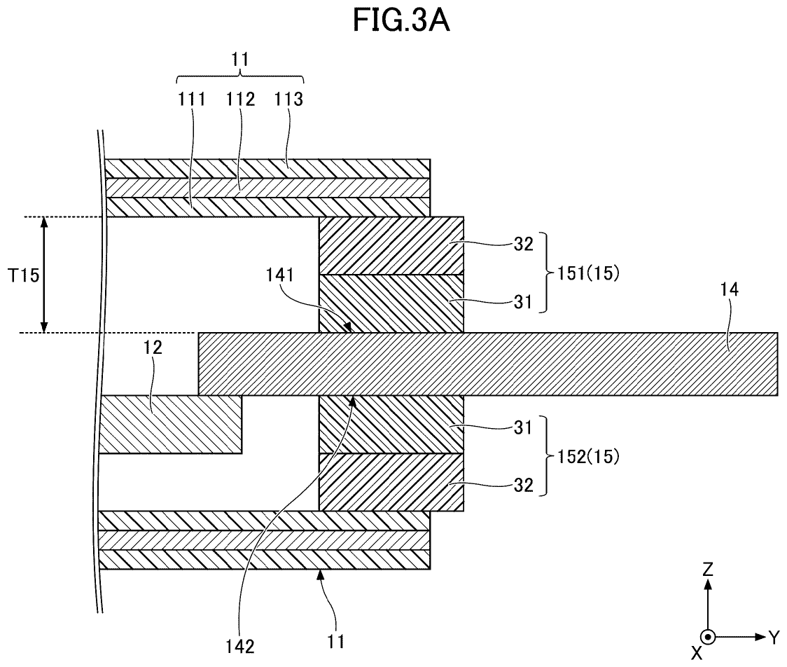

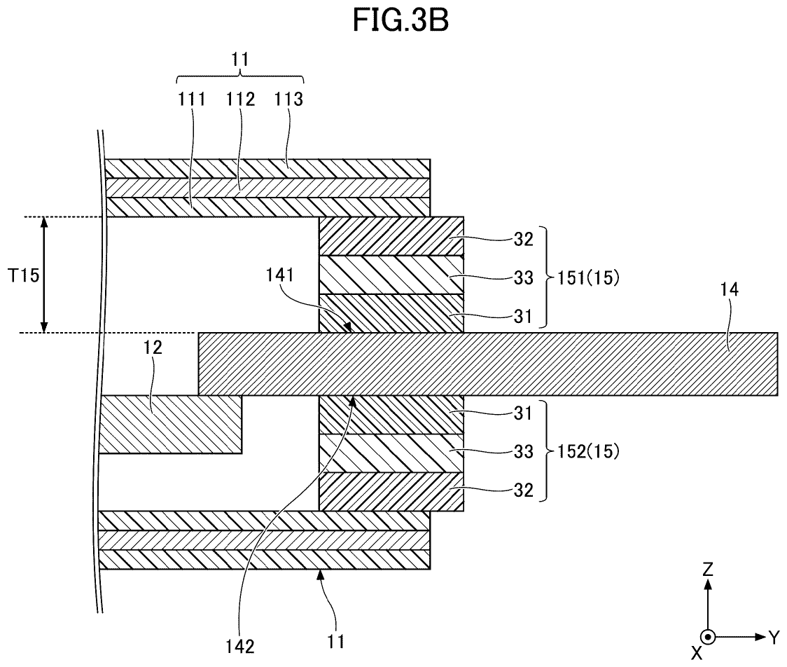

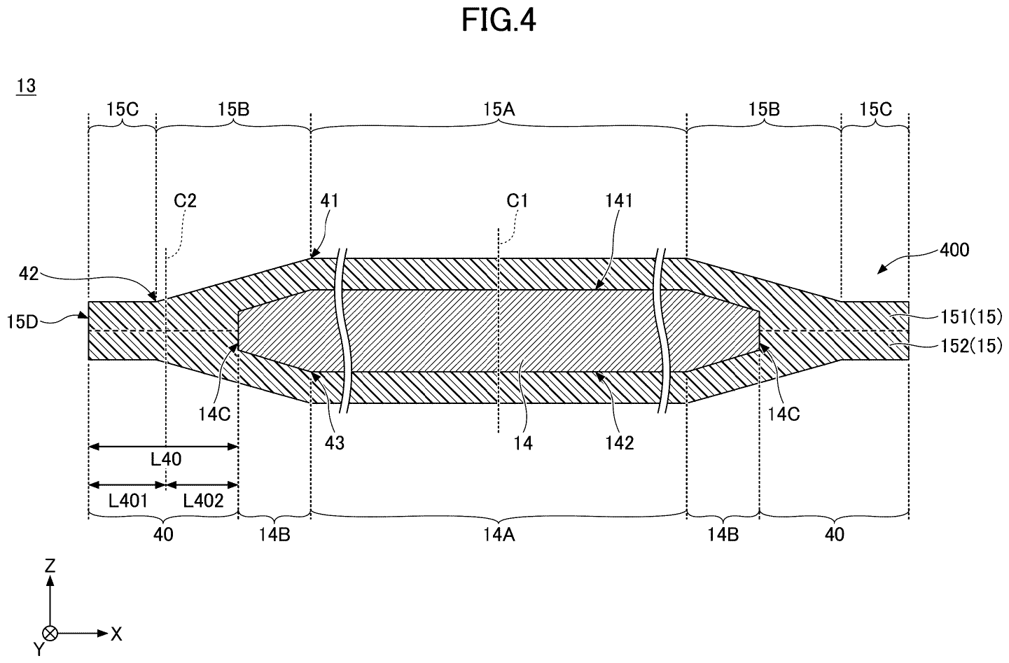

FIG. 1 is an explanatory view of a configuration example in which the lead with the electrically insulating resin film (hereinafter, also referred to as “lead”) of the embodiment is applied to a battery. FIG. 2 is an explanatory view of the lead with the electrically insulating resin film of the embodiment, as viewed from vertically above the top surface of the conductor. FIG. 3A illustrates a cross-sectional view taken along line A-A′ of FIG. 1. FIG. 3B illustrates another configuration example corresponding to a cross-sectional view taken along the line A-A′ of FIG. 1. FIG. 4 illustrates a cross-sectional view taken along line B-B′ of FIG. 2. Since FIG. 3B is a modification of the lead with the electrically insulating resin film of the embodiment, the description will be made mainly with reference to FIG. 1, FIG. 2, FIG. 3A, and FIG. 4, and FIG. 3B will be used as necessary.

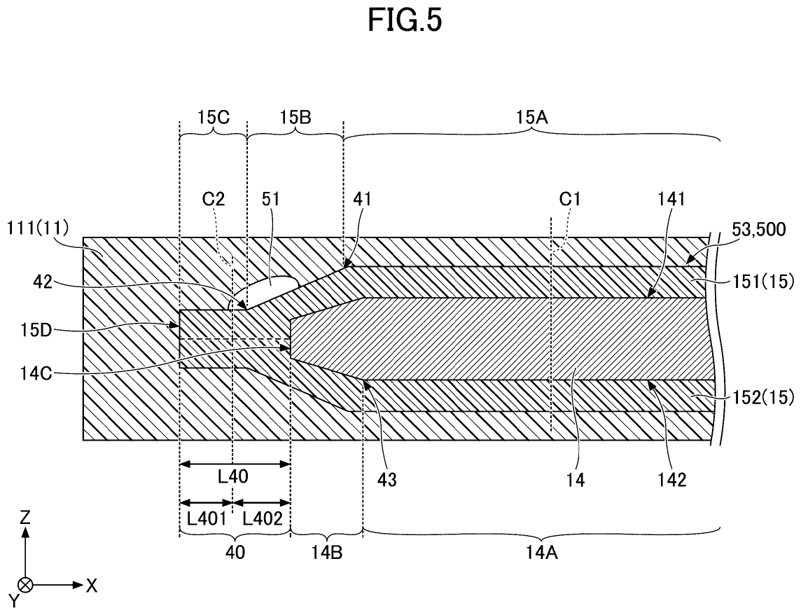

The Z-axis in FIG. 1, FIG. 2, FIG. 3A, FIG. 3B, FIG. 4, and FIG. 5 is an axis along the thickness of the conductor and the electrically insulating resin film of the lead of the embodiment.

A lead 13 of the embodiment can be applied to a battery. Thus, after describing the battery to which lead 13 of the embodiment can be applied, lead 13 of the embodiment will be described in detail.

### (1) About the Battery

A configuration example of the battery applying lead 13 according to the embodiment is illustrated in FIG. 1. As illustrated in FIG. 1, a battery 10 may include an exterior body 11, an electrode laminate 12 in which a positive electrode, a separator, and a negative electrode are laminated and that is impregnated with an electrolyte solution, and lead 13 according to the embodiment of the present disclosure that is connected to electrode laminate 12.

### (Exterior Body)

Exterior body 11 is a container that accommodates and seals electrode laminate 12 and the electrolyte. Exterior body 11 may include at least one resin layer on a surface facing electrode laminate 12 so as to be thermally welded.

As illustrated by a one dot chain line in FIG. 1, a seal portion 110 is formed at the peripheral edge of exterior body 11, and electrode laminate 12 and the electrolyte are sealed by seal portion 110.

### (2) About the Lead

Each member of lead 13 of the embodiment will be described.

### (2-1) Conductor

A conductor 14 is a member for connecting electrode laminate 12 disposed inside exterior body 11 and a device disposed outside exterior body 11. Conductor 14 can have a plate shape, and a top surface 141 and a bottom surface 142 (see FIG. 3A) have a rectangular shape. As illustrated in FIG. 2, top surface 141 of conductor 14 has two sides, a side 21 and a side 22 facing each other and two sides, a side 23 and a side 24 intersecting with side 21 and side 22. However, the rectangular shape does not indicate a geometrically strict shape, and conductor 14 may have a shape with rounded corners.

In the following description, an axis along side 21 and side 22, which are two sides selected to face each other when conductor 14 is viewed from above along the vertical direction of top surface 141, is referred to as an X-axis. Further, an axis orthogonal to the X-axis is defined as a Y-axis.

FIG. 4 illustrates a cross-sectional view of a multilayer body 400, in which an electrically insulating resin film 15 and conductor 14 are laminated, which is a cross-sectional view taken along the line B-B′ of FIG. 2, along the X-axis. As illustrated in FIG. 4, conductor 14 can have, at two ends 14C along the X-axis, tapered conductor portions 14B each having a thickness that decreases with increasing distance from a first center C1 that is a center of conductor 14 along the X-axis. First center C1 indicates the center between two ends 14C of conductor 14 along the X-axis.

Since conductor 14 has tapered conductor portions 14B at two ends 14C, it is possible to prevent a gap from forming between exterior body 11 of the battery and electrically insulating resin film 15 near a margin portion 40. The effect of preventing the gap is particularly significant when conductor 14 is made thicker.

In FIG. 4, each of tapered conductor portions 14B of conductor 14 has a bilaterally symmetrical shape at two ends 14C of conductor 14, but the present invention is not limited to such a form, and the gradient, the tapered shape, and the length along the X-axis of each of tapered conductor portions 14B may be different between the left and right. Further, top surface 141 and bottom surface 142 of conductor 14 may be, for example, different from each other in the gradient, the shape of the taper, and the length along the X-axis of tapered conductor portion 14B, and one of top surface 141 or bottom surface 142 may be a flat surface. Further, although two ends 14C of conductor 14 are formed in a straight line (flat surface) in FIG. 4, they may be formed in a curved line such as an arc shape.

Conductor 14 may include a flat portion 14A having a constant thickness in a region including first center C1 interposed between tapered conductor portions 14B. Flat portion 14A does not need to have a flat outer surface in a strict sense, and may have a thickness that varies within the range of manufacturing tolerance and include a non-flat portion.

In the following description, the end of tapered conductor portion 14B that is closer to first center C1 is referred to as a first conductor end 43. First conductor end 43 is a connection portion between flat portion 14A and tapered conductor portion 14B. First conductor end 43 can be set as a point at which conductor 14 starts to be thinner than flat portion 14A.

The material of conductor 14 is not particularly limited, and various materials used for a conductor of a lead can be used, for example. Examples of the material of conductor 14 include metal materials such as aluminum, titanium, nickel, copper, aluminum alloys, titanium alloys, nickel alloys, and copper alloys, and materials obtained by plating these metal materials with nickel, gold, or the like.

### (2-2) Electrically Insulating Resin Film

As illustrated in FIG. 3A and FIG. 4, electrically insulating resin film 15 includes a first electrically insulating resin film 151 disposed on top surface 141 of conductor 14 and a second electrically insulating resin film 152 disposed on bottom surface 142 of conductor 14. As illustrated in FIG. 2 and FIG. 3A, first electrically insulating resin film 151 and second electrically insulating resin film 152 are disposed on top surface 141 and bottom surface 142, respectively, so as to expose two ends of conductor 14 along the Y-axis, i.e., two ends including side 21 and side 22 from first electrically insulating resin film 151 and second electrically insulating resin film 152, without covering the two ends. Thus, on top surface 141 and bottom surface 142 of conductor 14, first electrically insulating resin film 151 and second electrically insulating resin film 152 are disposed to cover conductor 14 along the X-axis at the middle portion of conductor 14 except the two ends along the Y-axis.

Top surface 141 and bottom surface 142 of conductor 14 indicate surfaces facing exterior body 11 of battery 10 when battery 10 is manufactured.

In conductor 14, the two ends along the Y-axis indicate a first end region 25 including side 21 and a second end region 26 including side 22 as illustrated in FIG. 2. The intermediate portion is a portion positioned between first end region 25 and second end region 26.

First end region 25 is a portion exposed to the outside of exterior body 11, for example, when lead 13 is applied to the battery, and the size thereof can be chosen to enable the connection with an external device. Further, second end region 26, which is located inside exterior body 11 when lead 13 is applied to the battery, serves as the portion connected to electrode laminate 12 and the size thereof can be chosen to enable the connection with electrode laminate 12. First end region 25 and second end region 26 may have the same size, such as an area, or may have different sizes.

Thus, a length L14 of conductor 14 along the Y-axis is longer than a length L15 of electrically insulating resin film 15. Further, a length W15 of electrically insulating resin film 15 is longer than a length W14 of conductor 14 along the X-axis.

First electrically insulating resin film 151 and second electrically insulating resin film 152 are arranged to have margin portion 40 that overlaps each other and projects from two ends 14C of conductor 14 along the X-axis, as illustrated in FIG. 4. Margin portion 40 is a portion positioned outside conductor 14 from two ends 14C of conductor 14, and first electrically insulating resin film 151 and second electrically insulating resin film 152 are directly in contact with and bonded to each other.

In a cross-section along the X-axis of multilayer body 400 in which electrically insulating resin film 15 and conductor 14 are laminated, as illustrated in FIG. 4, multilayer body 400 includes a tapered resin portion 15B that has a thickness that decreases with increasing distance from first center C1.

As illustrated in FIG. 4, multilayer body 400 has, in a cross-section along the X-axis, a first flat portion 15A including first center C1 of conductor 14 and a second flat portion 15C positioned at two ends 15D along the X-axis. In addition, tapered resin portion 15B is disposed between first flat portion 15A and second flat portion 15C so as to connect first flat portion 15A to second flat portion 15C. First flat portion 15A and second flat portion 15C do not need to have a flat outer surface in a strict sense, and may have a thickness that varies within the range of manufacturing tolerance and include a non-flat portion.

In the following description, the end of tapered resin portion 15B that is close to first center C1 is referred to as a first resin end 41. Further, the end of tapered resin portion 15B that is farther from first center C1 than is first resin end 41 is referred to as a second resin end 42.

Lead 13 of the embodiment adheres with seal portion 110 (see FIG. 1) at the portion of electrically insulating resin film 15.

The inventors of the present invention have studied the cause of the void that may form between exterior body 11 and electrically insulating resin film 15 when the lead with the electrically insulating resin film and the exterior body are welded.

As a result, as illustrated in FIG. 5, which is a cross-section along the X-axis when a conventional lead 53 is thermally welded to exterior body 11, it was confirmed that a void 51 mainly forms in tapered resin portion 15B of electrically insulating resin film 15. In conventional lead 53, the position of first resin end 41 along the X-axis is farther from first center C1 than the position of first conductor end 43 is, and the length of tapered resin portion 15B along the X-axis is short, and the inclination is steep. Thus, it is considered that the resin of exterior body 11 cannot fill the vicinity of tapered resin portion 15B, and consequently void 51 forms.

Thus, in lead 13 of the embodiment, along the X-axis, the position of first resin end 41 is the same as the position of first conductor end 43, or is arranged at a position closer to first center C1 than the position of first conductor end 43 is. Further, along the X-axis, second resin end 42 is arranged at a position farther from first center C1 than end 14C of conductor 14 is.

As is clear from FIG. 4, in any one cross-section of multilayer body 400, first resin ends 41 and second resin ends 42 can be present at a total of four locations, two on top surface 141 of conductor 14 and two on bottom surface 142 of conductor 14, respectively, at the maximum. In any one cross-section of multilayer body 400, with respect to first resin ends 41 and second resin ends 42, at least one of the four positions may be arranged as described above, but all of the four positions may be arranged as described above.

By arranging the positions of first resin ends 41 and second resin ends 42 of tapered resin portions 15B as described above, the length of tapered resin portion 15B along the X-axis can be increased, and the inclination of the outer surface of tapered resin portion 15B can be made gradual. Thus, when lead 13 of the embodiment is thermally welded to exterior body 11, the resin of exterior body 11 is more likely to fill tapered resin portion 15B, thereby improving the adhesion between exterior body 11 and the formation of the void can be prevented.

It is noted that, in this specification, lead 13 having excellent adhesion to exterior body 11 indicates lead 13 capable of preventing the void from forming between exterior body 11 and electrically insulating resin film 15 when lead 13 is thermally welded to exterior body 11.

Second resin end 42 may be disposed at a position along the X-axis that is farther from first center C1 of conductor 14 than is a second center C2 that is the center of margin portion 40 along the X-axis.

By setting the position of second resin end 42 along the X-axis to a position farther from first center C1 of conductor 14 than second center C2 of margin portion 40 is, the length of tapered resin portion 15B along the X-axis in particular can be increased, and the inclination of tapered resin portion 15B in particular can be made gradual. Thus, when lead 13 of the embodiment is thermally welded to exterior body 11, the resin of exterior body 11 is more likely to fill tapered resin portion 15B, thereby greatly improving the adhesion with exterior body 11 and preventing the formation of the void.

Margin portion 40 is a region between end 14C of conductor 14 and end 15D of electrically insulating resin film 15. Second center C2 of margin portion 40 is a position where L401=L402, where L401 is a distance from end 15D of electrically insulating resin film 15 to second center C2 along the X-axis, and L402 is a distance from end 14C of conductor 14 to second center C2. When the length of margin portion 40 along the X-axis is L40, L40=L401+L402.

The shape of tapered resin portion 15B of electrically insulating resin film 15, for example, the positions of first resin end 41 and second resin end 42 can be easily adjusted by selecting, for example, the shape of a mold used when electrically insulating resin film 15 is welded to conductor 14, the welding conditions, and the like.

Length L40 of margin portion 40 along the X-axis is not particularly limited, but can be, for example, 5 mm or less. By setting length L40 of margin portion 40 to be 5 mm or less, the width of seal portion 110 sandwiching lead 13, which is a foreign substance, can be reduced, and the sealing property can be improved.

The lower limit of length L40 of margin portion 40 along the X-axis is not particularly limited, and can be, for example, 1 mm or greater. By setting length L40 of margin portion 40 along the X-axis to be 1 mm or greater, the adhesion between first electrically insulating resin film 151 and second electrically insulating resin film 152 is increased, and the formation of the gap between electrically insulating resin film 15 and conductor 14 in particular can be prevented.

The length of margin portion 40 along the X-axis can be, for example, 1 mm to 5 mm as described above.

Electrically insulating resin film 15 is a layer for enabling thermal welding with exterior body 11 when applied to a battery. Thus, electrically insulating resin film 15 may contain, for example, a thermoplastic resin as a resin. As the thermoplastic resin, for example, one or more kinds selected from a polyolefin resin, a polyester resin, a polystyrene resin, a polyvinyl chloride resin, and the like can be used. Examples of the polyolefin resin include polyethylene, polypropylene, and acid-modified polyolefin resins such as acid-modified polyethylene and acid-modified polypropylene. Examples of the polyester resin include a polyethylene terephthalate resin. Examples of the acid-modified polyolefin include maleic anhydride-modified polyolefins.

Electrically insulating resin film 15 can have two or more layers, as illustrated in FIG. 3A and FIG. 3B. Electrically insulating resin film 15 may include a base layer 31 and a surface layer 32 as illustrated in FIG. 3A. Electrically insulating resin film 15 may include base layer 31, an intermediate layer 33, and surface layer 32, as illustrated in FIG. 3B. When electrically insulating resin film 15 has three layers, the layers may be functionally separated, for example, a layer bonded to conductor 14, a layer bonded to exterior body 11, and a layer that is not easily crushed when lead 13 is welded to exterior body 11 and maintains strength. Thus, the material of each layer can

be selected according to the intended function and the like. The layer to be bonded to conductor 14 is preferably made of acid-modified polypropylene in view of the adhesion. The layer to be bonded to exterior body 11 may be made of a material having good adhesion to the material of exterior body 11.

Since the electrically insulating resin film has two or more layers, the strength of the electrically insulating resin film, the adhesion between the electrically insulating resin film and the exterior body, and the adhesion between the electrically insulating resin film and the conductor after the exterior body is thermally welded to the electrically insulating resin film can be easily adjusted.

A thickness T15 of electrically insulating resin film 15 is not particularly limited, and thickness T15 of electrically insulating resin film 15 can be set to 100 μm or greater, for example.

By setting thickness T15 of electrically insulating resin film 15 to 100 μm or greater, it is possible to prevent a gap from forming between electrically insulating resin film 15 and conductor 14.

Thickness T15 of electrically insulating resin film 15 can be set to, for example, 100 μm to 300 μm. It is noted that, thickness T15 of first electrically insulating resin film 151 may be different from or the same as that of second electrically insulating resin film 152. In addition, when electrically insulating resin film 15 has a plurality of layers, the total thickness of the plurality of layers is thickness T15.

By setting thickness T15 of electrically insulating resin film 15 to 300 μm or less, it is possible to particularly prevent a gap from forming between electrically insulating resin film 15 and exterior body 11 after exterior body 11 is thermally welded.

### EXAMPLE

The present invention will be described below with reference to specific examples, but the present invention is not limited to these examples.

The lead and battery in each example will be described below.

Example 1 is an example, and Example 2 is a comparative example. In both of Example 1 and Example 2, first electrically insulating resin film 151 and second electrically insulating resin film 152 had the same configuration.

### Example 1

Lead 13 illustrated in FIG. 2, FIG. 3A, and FIG. 4 was prepared, and exterior body 11 was thermally welded to lead 13. Electrically insulating resin film 15 has two layers, that is, base layer 31 containing maleic anhydride-modified polypropylene and surface layer 32 containing polypropylene, from a position close to conductor 14.

The shape of the mold and the heating conditions were selected so that the cross-section shape illustrated in FIG. 4 was obtained when electrically insulating resin film 15 was formed on top surface 141 and bottom surface 142 of conductor 14.

Thus, in multilayer body 400 of lead 13 of this example, in the cross section along the X-axis, a position of first resin end 41 along the X-axis is the same as a position of first conductor end 43 or is closer than the position of first conductor end 43 to first center C1 is, which indicates that a position of first resin end 41 is between first conductor end 43 and first center C1. Further, a position of second resin end 42 along the X-axis is farther from first center C1 than second center C2 is.

As illustrated in FIG. 4, first resin ends 41 and second resin ends 42 are present at two positions on top surface 141 of conductor 14 and two positions on bottom surface 142 of conductor 14, respectively, that is, at four positions in total, and in this example, the above-described arrangement is adopted for all of the four positions.

Length L40 of margin portion 40 was set to be 5 mm, and thickness T15 of electrically insulating resin film 15, that is, first electrically insulating resin film 151 and second electrically insulating resin film 152 was set to be 100 μm.

As exterior body 11, a laminate film in which a first resin layer 111 and a second resin layer 113 were polypropylene films and a metal layer 112 was an aluminum foil was used.

The positions of lead 13 and exterior body 11 were adjusted so that a part of electrically insulating resin film 15 along the Y-axis was covered with exterior body 11, and thermal welding was performed to form seal portion 110. There were two cases where the time for the thermal welding was 1.5 seconds and 3.0 seconds. In each case, the thermal welding was performed ten times to prepare ten samples. The heat welding conditions other than time were the same.

A cross-section of electrically insulating resin film 15 in a plane passing through the X-axis was observed. The evaluation results are indicated in Table 1. In Example 1, even when the thermal welding time was shortened, no void was observed between exterior body 11 and electrically insulating resin film 15, and it was observed that both members were in close contact with each other.

### Example 2

Lead 53 was produced under the same conditions as in Example 1 except that lead 13 was formed into the shape illustrated in FIG. 5, and exterior body 11 was thermally welded to lead 53, and the cross-section shape was evaluated.

Thus, in a multilayer body 500 of lead 53 of this example, in the cross section along the X-axis, a position of first resin end 41 along the X-axis is farther from first center C1 than the position of first conductor end 43 is. Further, the position of second resin end 42 along the X-axis is farther from first center C1 than end 14C of conductor 14 is, but is closer to first center C1 than second center C2 is, which indicates that the position of second resin end 42 is between first center C1 and second center C2. The evaluation results are indicated in Table 1.

When a cross-section of electrically insulating resin film 15 in a plane passing through the X-axis was checked at a plurality of positions, as illustrated in FIG. 5, voids 51 were observed in tapered resin portion 15B and second flat portion 15C in some cases.

TABLE 1

| | |
|---|---|
| | Number of samples with voids observed |
| | (Number of samples with voids observed/ |
| Thermal welding | Total number of samples observed) |

| time | 1.5 seconds | 3.0 seconds |
|---|---|---|
| Example 1 | 0/10 | 0/10 |
| Example 2 | 8/10 | 0/10 |

What is claimed is:

1. A lead with an electrically insulating resin film comprising:
a plate-shaped conductor with a top surface and a bottom surface each having a rectangular shape; and
an electrically insulating resin film including a first electrically insulating resin film disposed on the top surface of the conductor and a second electrically insulating resin film disposed on the bottom surface of the conductor;
wherein, when the conductor is viewed from above along a vertical direction of the top surface, an axis along selected two sides facing each other is an X-axis, and an axis orthogonal to the X-axis is a Y-axis, the conductor includes tapered conductor portions provided one each at two ends of the conductor along the X-axis, the tapered conductor portions each having a thickness that decreases with increasing distance from a first center that is a center of the conductor along the X-axis,
wherein the first electrically insulating resin film and the second electrically insulating resin film are arranged so as to cover the conductor by extending across the conductor along the X-axis such that the first and second electrically insulating resin films each have margin portions projecting from the two ends of the conductor and so as not to cover two ends of the conductor along the Y-axis, the margin portions of the first electrically insulating resin film overlapping the margin portions of the second electrically insulating resin film,
wherein, in a cross-section of a multilayer body along the X-axis, the multilayer body including the electrically insulating resin film and the conductor laminated together, the multilayer body includes tapered resin portions each having a thickness that decreases with increasing distance from the first center,
wherein the tapered conductor portions have first conductor ends close to the first center,
wherein the tapered resin portions have first resin ends closer to the first center and second resin ends farther from the first center than the first resin ends are,
wherein, along the X-axis, a position of each of the first resin ends is the same as a position of a corresponding one of the first conductor ends or is closer to the first center than the position of the corresponding first conductor end is, and
wherein, a position of each of the second resin ends along the X-axis is farther from the first center than a corresponding one of the two ends of the conductor along the X-axis is.

2. The lead with the electrically insulating resin film according to claim 1,
wherein the position of each of the second resin ends along the X-axis is farther from the first center than is a second center that is a center of a corresponding one of the margin portions along the X-axis.

3. The lead with the electrically insulating resin film according to claim 1,
wherein the electrically insulating resin film has two or more layers.

4. The lead with the electrically insulating resin film according to claim 1,
wherein a thickness of the electrically insulating resin film is 100 μm or greater.

5. The lead with the electrically insulating resin film according to claim 1,
wherein a length of each of the margin portions along the X-axis is 5 mm or less.
